(19) United States
(12) Patent Application Publication
(10) Pub. No.: US 2022/0361399 A1
(43) Pub. Date: Nov. 17, 2022

(54) AERIAL LAWNMOWER

(71) Applicant: James Schaad, Waterford, OH (US)

(72) Inventor: James Schaad, Waterford, OH (US)

(21) Appl. No.: 17/745,285

(22) Filed: May 16, 2022

Related U.S. Application Data
(60) Provisional application No. 63/188,878, filed on May 14, 2021.

(51) Int. Cl. A01D 34/00; A01D 34/64; B64C 39/02

(52) U.S. Cl. CPC A01D 34/008; A01D 34/64; B64C 39/024; A01D 2101/00

(57) ABSTRACT

An aerial lawnmower, including a main body, a mower assembly disposed on at least a portion of a first end of the main body to cut at least one vegetation in response to rotating, and a plurality of rotors disposed on at least a portion of a second end of the main body to perform at least one of increase and decrease an elevation of the main body in response to rotating.

### CROSS-REFERENCE TO RELATED APPLICATIONS

This application claims priority under 35 USC § 120 from U.S. Provisional Application No. 63/188,878, entitled “Aerial Lawnmower,” which was filed on May 14, 2021, in the United States Patent and Trademark Office, the disclosure of which is incorporated herein in its entirety by reference.

### BACKGROUND

### 1. Field

The present general inventive concept relates generally to a lawnmower, and particularly, to an aerial lawnmower.

### 2. Description of the Related Art

Studies have shown that approximately eight thousand people visit a hospital each year due to lawnmower-related injuries. Any lawn located on an inclined surface, such as a hill, a mountain, and/or a slope is difficult to cut because of an increased risk of falling. Specifically, the inclined surface can cause a riding lawnmower to become unbalanced during use. As such, if the riding lawnmower is driven at a steep angle, there is an increased chance of injury from the riding lawnmower tipping over.

Also, a push lawnmower can be difficult to use on the inclined surface for similar reasons as the riding lawnmower. The push lawnmower will be pulled down the inclined surface from gravity, which increases the risk of injury for a user.

Therefore, there is a need for a lawnmower that is unaffected by inclined surfaces.

### SUMMARY

The present general inventive concept provides an aerial lawnmower.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an aerial lawnmower, including a main body, a mower assembly disposed on at least a portion of a first end of the main body to cut at least one vegetation in response to rotating, and a plurality of rotors disposed on at least a portion of a second end of the main body to perform at least one of increase and decrease an elevation of the main body in response to rotating.

The aerial lawnmower may further include a boom joint pivotally disposed on at least a portion of the second end of the main body to pivot to at least one position, and a plurality of booms disposed away from the boom joint and connected to the plurality of rotors to extend the plurality of rotors away from the main body.

The mower assembly may include a mower hood, and a detachable cutting unit detachably connected to at least a portion of the mower hood to cut the at least one vegetation.

The mower assembly may further include a plurality of sensors disposed on at least a portion of the mower hood to monitor a distance therefrom to an obstruction, such that the main body moves away from the obstruction in response to the plurality of sensors detecting the obstruction.

The aerial lawnmower may further include a control unit disposed on at least a portion of the main body to control a length of the at least one vegetation cut by automatically adjusting a height of the mower assembly during flight over the at least one vegetation.

The control unit may determine the length of the at least one vegetation for cutting using a camera.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of an aerial lawnmower, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the FIGURES and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Aerial Lawnmower 100

Main Body 110

Boom Joint 111

Booms 112

Mower Assembly 120

Mower Hood 121

Detachable Cutting Unit 122

Sensors 123

Motor 130

Rotors 140

Control Unit 150

Processing Unit 151

Communication Unit 152

Storage Unit 153

Charging Port 154

Camera 160

Power Source 170

Software Application 180

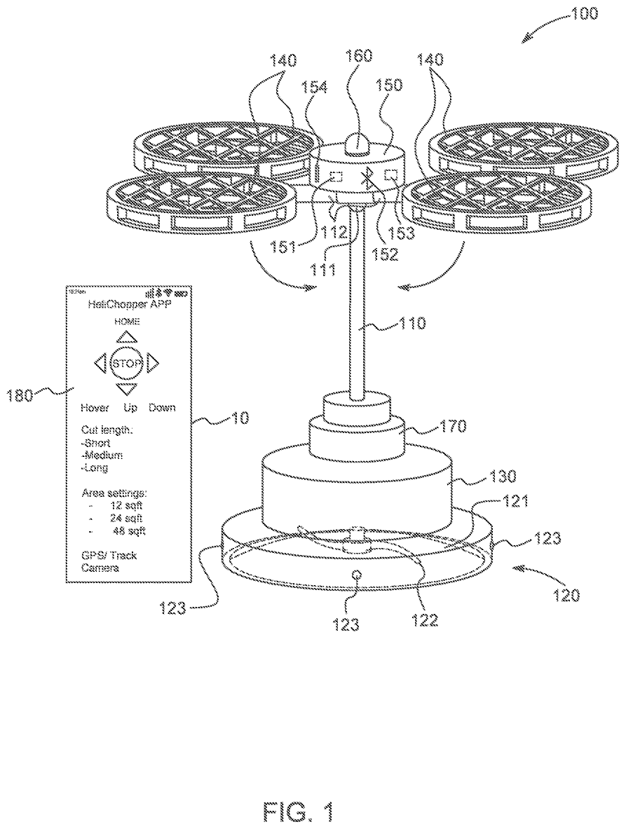

FIG. 1 illustrates a side perspective view of an aerial lawnmower 100, according to an exemplary embodiment of the present general inventive concept.

The aerial lawnmower 100 may be constructed from at least one of metal, plastic, wood, glass, and rubber, etc., but is not limited thereto.

The aerial lawnmower 100 may include a main body 110, a mower assembly 120, a motor 130, a plurality of rotors 140, a control unit 150, a camera 160, a power source 170, and a software application 180, but is not limited thereto.

The main body 110 may include a boom joint 111 and a plurality of booms 112, but is not limited thereto.

Referring to FIG. 1, the main body 110 is illustrated as an elongated structure. The main body 110 may be cylindrical, rectangular, triangular, pentagonal, hexagonal, heptagonal, octagonal, or any other shape known to one of ordinary skill in the art.

The boom joint 111 may be pivotally (i.e., rotationally) disposed on at least a portion of a first end of the main body 110. The boom joint 111 may pivot to any position.

Referring again to FIG. 1, the plurality of booms 112 is illustrated to have two booms. However, the plurality of booms 112 may be a single boom, three booms, four booms, five booms, six booms, seven booms, eight booms, and/or any other number based on a preference of a user and/or a manufacturer.

The plurality of booms 112 may be perpendicularly disposed away from the first end of the main body 110 with respect to a first direction, and a second direction opposite with respect to the first direction. The plurality of booms 112 may pivot (i.e., rotate) along a center portion thereof, such that the plurality of booms 112 may bend and/or fold for storage. Also, the plurality of booms 112 may be connected to the boom joint 111.

The mower assembly 120 may include a mower hood 121, a detachable cutting unit 122, and a plurality of sensors 123, but is not limited thereto.

The mower hood 121 may be connected to at least a portion of a second end of the main body 110.

The detachable cutting unit 122 may include a plurality of lawnmower blades, a string trimmer (e.g., weed whacker), and/or a plurality of toothed blades (e.g., bush cutter), but is not limited thereto.

The detachable cutting unit 122 may be detachably and/or rotatably connected to at least a portion of a bottom portion of the mower hood 121. Moreover, the detachable cutting unit 122 may be exchanged for another attachment. For example, the plurality of lawnmower blades may be exchanged for the string trimmer and/or the plurality of toothed blades depending on the preference of the user. Additionally, the detachable cutting unit 122 may cut at least one vegetation (e.g., grass, weeds, bushes) in response to rotating.

Each of the plurality of sensors 123 may include a distance sensor and an infrared sensor, but is not limited thereto.

The plurality of sensors 123 may be disposed on at least a portion of the mower hood 121. For example, the plurality of sensors 123 may be disposed at four points around the mower hood 121. The plurality of sensors 123 may monitor a distance between the plurality of sensors 123 and/or an obstruction, such as an external object (e.g., a rock, a tree, a building, a vehicle, etc.), an external surface (e.g., a ground surface, a wall, a road), and/or a person. Additionally, the plurality of sensors 123 may send a proximity warning in response to detecting the distance from the plurality of sensors 123 to the obstruction is equivalent and/or less than a predetermined distance (e.g., one inch). Alternatively, and/or in addition thereto, the plurality of sensors 123 may send the proximity warning in response to detecting the distance from the detachable cutting unit 122 to the obstruction is equivalent and/or less than the predetermined distance. As such, the plurality of sensors 123 may prevent damage to the detachable cutting unit 122 and/or the obstruction.

The motor 130 may be connected to at least a portion of the second end of the main body 110 and/or connected to the mower assembly 120. More specifically, the detachable cutting unit 122 may rotate in response to rotation of the motor 130.

Each of the plurality of rotors 140 may be disposed on at least one of the plurality of booms 112. In other words, a number of the plurality of rotors 140 may correspond to a number of the plurality of booms 112. Furthermore, the plurality of motors 140 may be connected to the motor 130, such that the plurality of rotors 140 may rotate in response to rotation of the motor 130. Therefore, the plurality of rotors 140 may increase and/or decrease an elevation of the main body 110 in response to rotating. As such, the plurality of rotors 140 may facilitate flight.

The control unit 150 may include a processing unit 151, a communication unit 152, a storage unit 153, and a charging port 154, but is not limited thereto.

The control unit 150 may be disposed on at least a portion of the first end of the main body 110. Also, the control unit 150 may electrically connected to the motor 130 and/or the plurality of rotors 140.

The processing unit 151 (or central processing unit, CPU) may include electronic circuitry to carry out instructions of a computer program by performing basic arithmetic, logical, control and input/output (I/O) operations specified by the instructions. The processing unit 151 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 151 may also include a microprocessor and a microcontroller.

The communication unit 152 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 153 may include a random access memory (RAM), a read-only memory (ROM), a hard disk, a flash drive, a database connected to the Internet, cloud-based storage, Internet-based storage, or any other type of storage unit.

The processing unit 151 may access the Internet via the communication unit 152 to allow a user to access a website, and/or may allow a mobile application and/or a software application 180 to be executed using the processing unit 151. For ease of description, the mobile and/or the software application will be hereinafter referred to as an app 180. The app 180 may be downloaded from the Internet to be stored on the storage unit 153. Also, the app 180 may be downloaded and/or installed on an external device 10 (e.g., a mobile device, a cell phone, a tablet computer, a personal digital assistant (PDA), a laptop computer). As such, the external device 10 may control the control unit 150 therefrom.

The processing unit 151 executing the app 180 may control a rotation speed of the plurality of rotors 140. In other words, the plurality of rotors 140 may increase the rotation speed to increase elevation of the main body 110 and/or decrease the rotation speed to decrease elevation of the main body 110. Moreover, the processing unit 151 executing the app 180 may control a position of the plurality of booms 112 with respect to the main body 110, such that the plurality of rotors 140 may move the main body 110 in a variety of directions. As such, the plurality of booms 112 may facilitate steering and/or a direction of flight by changing an angle of the plurality of rotors 140.

Additionally, the processing unit 151 executing the app 180 may control the rotation speed of the detachable cutting unit 122. Also, the processing unit 151 executing the app 180 may control a length of grass cut by adjusting a height during flight over the grass. Furthermore, the processing unit 151 executing the app 180 may receive commands to cut the at least one vegetation based on the plurality of sensors 123 detecting the at least one vegetation exceeds a predetermined length (e.g., three inches, four inches, five inches, etc.). Therefore, the processing unit 151 executing the app 180 may automatically determine to move the main body 110 toward the at least one vegetation for cutting based on signals from the plurality of sensors 123 without manual input from the external device 10.

Also, the plurality of sensors 123 may send the proximity warning to the processing unit 151 based on detecting an infrared signal based on a heat signature of a person. As such, the processing unit 151 executing the app 180 may control the main body 110 to move away from the person.

The processing unit 151 may temporarily suspend (i.e. stop) operation of the motor 130 in response to the plurality of sensors 123 detecting the distance from the detachable cutting unit 122 to the obstruction is equivalent and/or less than the predetermined distance. As such, the processing unit 151 and/or the plurality of sensors 123 may prevent damage to the detachable cutting unit 122 and/or the obstruction.

The camera 160 may include any type of camera known to one of ordinary skill in the art, including, but not limited to, an action camera, an animation camera, an autofocus camera, a box camera, a camcorder, a camera phone, a compact camera, a dashboard camera (i.e., a Dashcam), a digital camera, a field camera, a FIREWIRE camera, a helmet camera, a high-speed camera, an instant camera, a keychain camera, a live-preview digital camera, a movie camera, an omnidirectional camera, a pinhole camera, a pocket camera, a pocket video camera, a rangefinder camera, a reflex camera, a remote camera, a stereo camera, a still camera, a still video camera, a subminiature camera, a system camera, a thermal imaging camera, a thermographic camera, a traffic camera, a traffic enforcement camera, a twin-lens reflex camera, a video camera, a view camera, a webcam, a WRIGHT camera, a ZENITH camera, a zoom-lens reflex camera.

The camera 160 may be disposed on at least a portion of the control unit 150. The camera 160 may record at least one picture and/or at least one video thereon, such as a surrounding environment. Moreover, the camera 160 may send a visual signal to the processing unit 151, such that the processing unit 151 may determine the length of the at least one vegetation for cutting. Furthermore, the camera 160 may provide the at least one picture and/or the at least one video to the external device 10.

The power source 170 may include a battery and a solar cell, but is not limited thereto.

The power source 170 may be disposed on at least a portion of the second end of the main body 110. The power source 170 may send power to the mower assembly 120, the motor 130, the plurality of rotors 140, the control unit 150, and/or the camera 170.

Therefore, the aerial lawnmower 100 may be unaffected by inclined surfaces during cutting of the at least one vegetation. Also, the aerial lawnmower 100 may prevent injury to the user.

The present general inventive concept may include an aerial lawnmower 100, including a main body 110, a mower assembly 120 disposed on at least a portion of a first end of the main body 110 to cut at least one vegetation in response to rotating, and a plurality of rotors 140 disposed on at least a portion of a second end of the main body 110 to perform at least one of increase and decrease an elevation of the main body 110 in response to rotating.

The aerial lawnmower 100 may further include a boom joint 111 pivotally disposed on at least a portion of the second end of the main body 110 to pivot to at least one position, and a plurality of booms 112 disposed away from the boom joint 111 and connected to the plurality of rotors 140 to extend the plurality of rotors 140 away from the main body 110.

The mower assembly 120 may include a mower hood 121, and a detachable cutting unit 122 detachably connected to at least a portion of the mower hood 121 to cut the at least one vegetation.

The mower assembly 120 may further include a plurality of sensors 123 disposed on at least a portion of the mower hood 121 to monitor a distance therefrom to an obstruction, such that the main body 110 moves away from the obstruction in response to the plurality of sensors 123 detecting the obstruction.

The aerial lawnmower 100 may further include a control unit 150 disposed on at least a portion of the main body 110 to control a length of the at least one vegetation cut by automatically adjusting a height of the mower assembly 120 during flight over the at least one vegetation.

The control unit 150 may determine the length of the at least one vegetation for cutting using a camera 160.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An aerial lawnmower, comprising:
a main body;
a mower assembly disposed on at least a portion of a first end of the main body to cut at least one vegetation in response to rotating; and
a plurality of rotors disposed on at least a portion of a second end of the main body to perform at least one of increase and decrease an elevation of the main body in response to rotating.

2. The aerial lawnmower of claim 1, further comprising:
a boom joint pivotally disposed on at least a portion of the second end of the main body to pivot to at least one position; and
a plurality of booms disposed away from the boom joint and connected to the plurality of rotors to extend the plurality of rotors away from the main body.

3. The aerial lawnmower of claim 1, wherein the mower assembly comprises:
a mower hood; and
a detachable cutting unit detachably connected to at least a portion of the mower hood to cut the at least one vegetation.

4. The aerial lawnmower of claim 3, wherein the mower assembly further comprises:
a plurality of sensors disposed on at least a portion of the mower hood to monitor a distance therefrom to an obstruction, such that the main body moves away from the obstruction in response to the plurality of sensors detecting the obstruction.

5. The aerial lawnmower of claim 1, further comprising:
a control unit disposed on at least a portion of the main body to control a length of the at least one vegetation cut by automatically adjusting a height of the mower assembly during flight over the at least one vegetation.

6. The aerial lawnmower of claim 5, wherein the control unit determines the length of the at least one vegetation for cutting using a camera.
